(19) United States
(12) Patent Application Publication
(10) Pub. No.: US 2002/0196934 A1
(43) Pub. Date: Dec. 26, 2002

(54) Telephone keypad with dot expression capability

(76) Inventor: Tetsunori Kunimune, Burbank, CA (US)

Correspondence Address: Eugene Oak, 610 S. Van Ness Ave., Los Angeles, CA, 90005, US

(21) Appl. No.: 09/886,721

(22) Filed: Jun. 22, 2001

(51) Int. Cl. H04M 1/00; H04M 9/00

(52) U.S. Cl. 379/433.06

(57) ABSTRACT

A telephone keypad, which is capable of communicating the dot symbol. A button in the central area of the keypad has raised dots on its surface. Said button represents the “dot” symbol and communicates said symbol when it is pressed by user.

### FIELD OF THE INVENTION

The present invention generally relates to a telephone keypad arrangement, more particularly to an arrangement that comprises a key representing a dot or a period for use in denoting addresses including but not limited to Internet addresses.

### BACKGROUND OF THE INVENTION

Many touch tone telephone equipment in the prior art such as common house hold phones exhibit a raised dot on the “5” button on the key pad. The reason for the raised dot is to help determine the placement of the keys with respect to a centrally located button. In most cases, the button representing the numeral 5 displays said raised dot. This is also helpful for the vision impaired so that a person may determine the location of the keys by sensing the raised dot.

The prior art describes a function, which relates to ease of location. However, the present invention performs this function and another more important function. The present invention seeks to represent the symbol “.” by the use of a telephone key pad. This representation will allow the user to communicate world wide web addresses and other address forms including but not limited to, the dot, such as .com or .net.

There is presently no invention, which utilizes a raised dot on a phone button as the present invention does. Yet the present invention incurs many of the convenience and benefits described above. Thus there is presently a need for the novel features possessed by the present invention.

### BRIEF SUMMARY OF THE INVENTION

The present invention is a button on a telephone key pad consisting of five raised dots of a particular shape including but not limited to hemispherical. Said dots are easily detected by lightly placing a finger over the dots and thus aids in the location of the numbers as they appear on the buttons of the keypad.

It is an object of the present invention to allow a telephone user to denote the dot symbol by pressing a key on the keypad so that the user may express a variety of address codes and commands that were formerly not possible.

These together with other objects of the invention are pointed out clearly in the claims annexed to and forming a part of this disclosure. For a better understanding of the present invention, its operating advantages and the specific objects attained by its use, references should be made to the accompanying drawings and descriptive matter in which there are illustrated preferred embodiments of the invention.

### BRIEF DESCRIPTION OF THE DRAWINGS

For a better understanding of the nature of the present invention, reference should be made to the following detailed description taken in connection with the accompanying drawing wherein:

FIG.1 is a front view of the entire telephone keypad

FIG.2 is a close-up perspective view of the preferred embodiment of the present invention.

### DETAILED DESCRIPTION OF THE PREFERRED EMBODIMENT

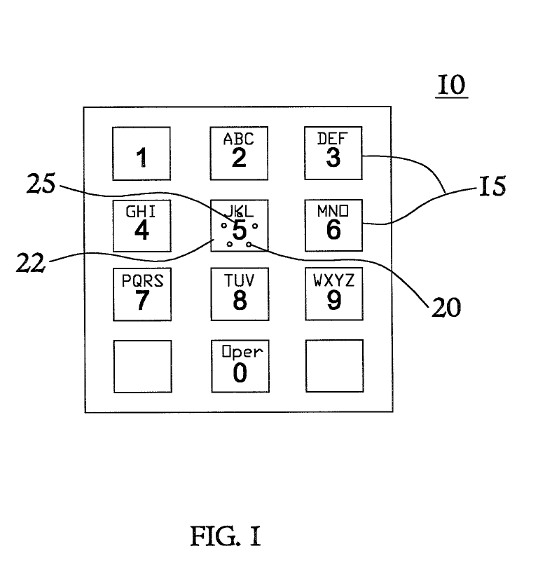

Referring now to FIG. 1, the preferred embodiment of the present invention comprises a telephone keypad 10 having buttons 15. Each button 15 denotes a different number and various letters of the alphabet. This is a commonly seen set up for a telephone keypad matrix and is very well known in the prior art. The present invention, however, has five raised dots 20 located on the key representing the numeral “5” 22. The dots 20 are tiny raised Braille-like features, which can be readily detected by the user as the user passes a finger over the surface of button 22.

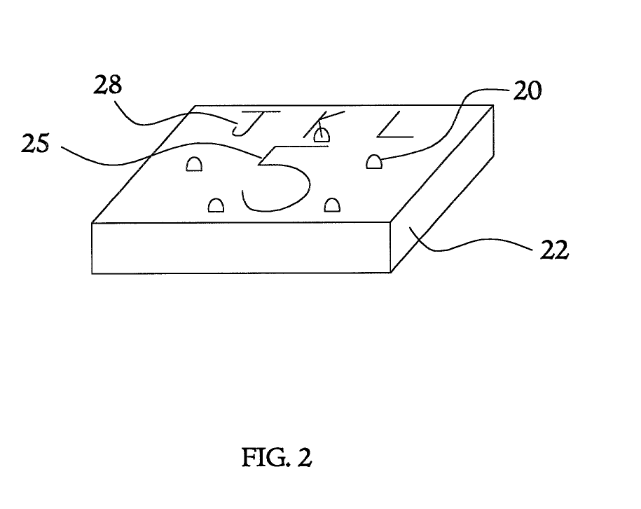

Looking now at FIG. 2, the five raised dots are situated around the picture of the numeral “5” 25 and the letters “JKL” 28. The button not only denotes letters and a number but the punctuation mark “.” Commonly known as a period or a “dot” in the internet sense. By pressing the dot button 22, the user may express the “dot” in Internet languages including but not limited to “.com” or “.net” by use of their keypad.

The above is a preferred embodiment of the present invention and does not limit the scope of the features to what has been thus far described.

What is claimed is:

1. Telephone keypad arrangement, which comprises a button with five raised dots on its surface.

2. Telephone keypad arrangement in accordance with claim 1 wherein said button is capable of expressing a “.” in Internet language.

3. Telephone keypad arrangement in accordance with claim 1 wherein the number of said raised dots is two.

4. Telephone keypad arrangement in accordance with claim 1 wherein the number of said raised dots is three.

5. Telephone keypad arrangement in accordance with claim 1 wherein the number of said raised dots is four.

6. Telephone keypad arrangement in accordance with claim 1 wherein the number of said raised dots is five.

7. Telephone keypad arrangement in accordance with claim 1 wherein the number of said raised dots is six.

8. Telephone keypad arrangement in accordance with claim 1 wherein the number of said raised dots is seven.

9. Telephone keypad arrangement in accordance with claim 1 wherein the number of said raised dots is eight.

10. Telephone keypad arrangement in accordance with claim 1 wherein the number of said raised dots is nine.

11. Telephone keypad arrangement in accordance with claim 1 wherein said button exhibits a plurality of raised dots.
